(19) United States
(12) Patent Application Publication
(10) Pub. No.: US 2022/0343361 A1
(43) Pub. Date: Oct. 27, 2022

(54) SYSTEM AND METHOD FOR OFFERING BOUNTIES TO A USER IN REAL-TIME

(71) Applicants: LAKSHMINATH REDDY DONDETI, San Jose, CA (US); VIDYA NARAYANAN, San Jose, CA (US)

(72) Inventors: LAKSHMINATH REDDY DONDETI, San Jose, CA (US); VIDYA NARAYANAN, San Jose, CA (US)

(21) Appl. No.: 17/726,535

(22) Filed: Apr. 22, 2022

Related U.S. Application Data
(60) Provisional application No. 63/177,959, filed on Apr. 22, 2021.

(51) Int. Cl. G06Q 30/02; G06Q 50/00

(52) U.S. Cl. CPC G06Q 30/0241; G06Q 50/01

(57) ABSTRACT

Exemplary embodiments of the present disclosure are directed towards a system and method for offering bounties to a user in real-time, comprising computing devices configured to establish communication with a server over a network; a content creation and bounties generation module configured to enable a user to access a bounty icon, and allow the user to access, select and trim the media tracks on the computing device, the content creation and bounties generation module configured to enable the user to create content by using the trimmed media tracks and allow to post the created content on the computing device, a user activities monitoring module configured to validate the user posted content and generates milestones to the user based on the user posted content, and the user activities, the user activities monitoring module configured to generate bounties to the user upon reaching one or more milestones.

### CROSS-REFERENCE TO RELATED APPLICATIONS

This patent application claims priority benefit of U.S. Provisional Patent Application No. 63/177,959, entitled “METHOD AND APPARATUS FOR BOUNTY CREATION”, filed on 22 Apr. 2021. The entire contents of the patent application are hereby incorporated by reference herein in its entirety.

### COPYRIGHT AND TRADEMARK NOTICE

This application includes material which is subject or may be subject to copyright and/or trademark protection. The copyright and trademark owner(s) have no objection to the facsimile reproduction by any of the patent disclosure, as it appears in the Patent and Trademark Office files or records, but otherwise reserves all copyright and trademark rights whatsoever.

### TECHNICAL FIELD

The disclosed subject matter relates generally to providing bounties to a user based on their activities on a digital platform. More particularly, the present disclosure relates to a system and computer-implemented method for offering bounties to a user in real-time.

### BACKGROUND

Social media portals are booming these days, and social media portals have become a modern arena for human life, with billions of daily users worldwide. One of the most common functionalities of these social media portals is connecting with friends, family members, co-workers, or people with similar interests to allow open communication and sharing amongst such connections. These social media portals enable users to like, friend, follow, comment, or otherwise take some action with the content or accounts of others. Many social media platforms offer user rewards based on user activities. However, the users expect real money rewards and coupons for spending time on the social media platform and creating the content on the social media platform.

In the light of the aforementioned discussion, there exists a need for a certain system and computer implemented method for offering bounties to a user in real-time with novel methodologies.

### SUMMARY

The following invention presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

An objective of the present disclosure is directed towards a system and computer implemented method for offering bounties to a user in real-time.

Another objective of the present disclosure is directed towards providing bounties to the user based on their activities on a digital platform.

Another objective of the present disclosure is directed towards providing bounties on the media tracks.

Another objective of the present disclosure is directed towards enabling the user to access the media tracks for making videos.

Another objective of the present disclosure is directed towards providing bounties on multiple elements (for example, specific posts, hashtags, prompts, collabs, templates, films, transitions).

Another objective of the present disclosure is directed towards representing the available bounties on the elements and the media tracks by a special icon or bounty icon.

Another objective of the present disclosure is directed towards providing specific bounties to the particular user based on multiple parameters (for example, the user location, a genre of videos of the user).

Another objective of the present disclosure is directed towards allowing the user to post unlimited posts (no limit).

Another objective of the present disclosure is directed towards providing milestones to the user.

Another objective of the present disclosure is directed towards providing a leaderboard with a status of all activities associated with bounties.

Another objective of the present disclosure is directed towards providing bounties to the user based on the user activities, accessing icons, trimming media tracks, etc.

Another objective of the present disclosure is directed towards allowing the user to nominate their favorite creators for awards or bounties.

According to an exemplary aspect of the present disclosure, enabling the user to request one or more media tracks on a computing device by a content creation and bounties generation module.

According to another exemplary aspect of the present disclosure, retrieving the one or more media tracks with bounties details by a user activities monitoring module enabled in a server.

According to another exemplary aspect of the present disclosure, delivering the one or more media tracks with the bounties details to the computing device from the server over a network, thereby displaying the one or more media tracks with the bounties details on the computing device by the content creation and bounties generation module.

According to another exemplary aspect of the present disclosure, allowing the user to access the one or more media tracks on the computing device by the content creation and bounties generation module.

According to another exemplary aspect of the present disclosure, allowing the user to select and trim the one or more media tracks by the content creation and bounties generation module.

According to another exemplary aspect of the present disclosure, allowing the user to create content using the one or more trimmed media tracks by the content creation and bounties generation module.

According to another exemplary aspect of the present disclosure, validating the user created content by the user activities monitoring module enabled in the server.

According to another exemplary aspect of the present disclosure, allowing the user to post the created content on the computing device by the content creation and bounties generation module.

According to another exemplary aspect of the present disclosure, generating one or more milestones to the user by the user activities monitoring module based on the content posted by the user on the computing device.

According to another exemplary aspect of the present disclosure, monitoring the one or more milestones of the user by the user activities monitoring module.

According to another exemplary aspect of the present disclosure, offering one or more bounties to the user upon reaching the one or more milestones by the user activities monitoring module.

### BRIEF DESCRIPTION OF THE DRAWINGS

In the following, numerous specific details are set forth to provide a thorough description of various embodiments. Certain embodiments may be practiced without these specific details or with some variations in detail. In some instances, certain features are described in less detail so as not to obscure other aspects. The level of detail associated with each of the elements or features should not be construed to qualify the novelty or importance of one feature over the others.

FIG. 1 is a block diagram depicting a schematic representation of a system for offering bounties to a user in real-time, in accordance with one or more exemplary embodiments.

FIG. 2 is a block diagram depicting an embodiment of the content creation and bounties generation module 116 on the computing devices and the user activities monitoring module 118 on the server as shown in FIG. 1, in accordance with one or more exemplary embodiments.

FIG. 3 is a flow diagram depicting a method for offering bounties to a user in real-time, in accordance with one or more exemplary embodiments.

FIG. 4 is a flow diagram depicting a method for accessing media tracks and posting the content, in accordance with one or more exemplary embodiments.

FIG. 5 is a flow diagram depicting a method for generating milestones and adding the user to winner slots of milestones, in accordance with one or more exemplary embodiments.

FIG. 6 is a flow diagram depicting a method for providing incentivized series to the user by an incentivized series providing module, in accordance with one or more exemplary embodiments.

FIG. 7 is a block diagram illustrating the details of a digital processing system in which various aspects of the present disclosure are operative by execution of appropriate software instructions.

### DETAILED DESCRIPTION OF EXAMPLE EMBODIMENTS

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced item. Further, the use of terms “first”, “second”, and “third”, and so forth, herein do not denote any order, quantity, or importance, but rather are used to distinguish one element from another.

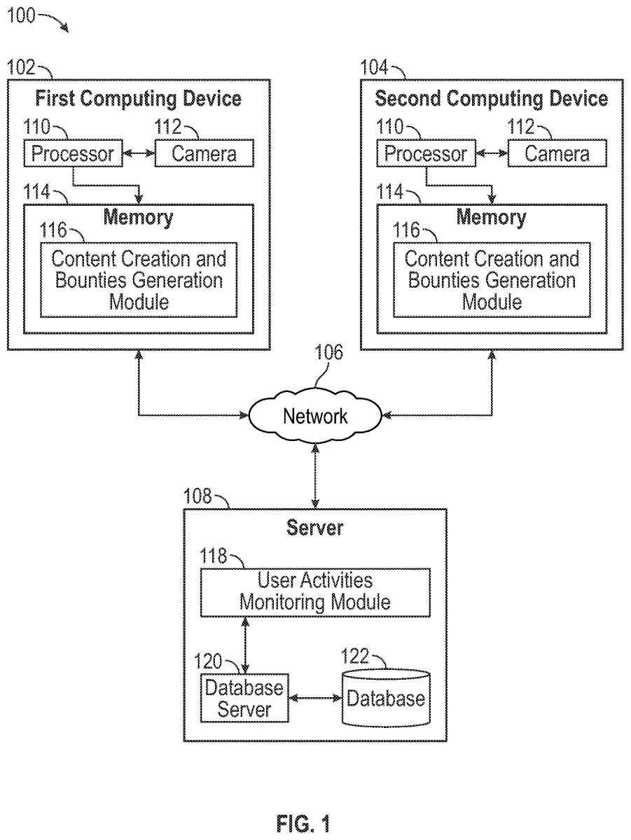

Referring to FIG. 1 is a block diagram depicting a schematic representation of a system for offering bounties to a user in real-time, in accordance with one or more exemplary embodiments. The system 100 includes a first computing device 102, a second computing device 104, a network 106, a server 108, a processor 110, a camera 112, a memory 114, a content creation and bounties generation module 116, a user activities monitoring module 118, a database server 120, and a database 122.

The computing devices 102, 104 may include users' devices. The computing devices 102, 104 may include, but is not limited to, a personal digital assistant, smartphones, personal computers, a mobile station, computing tablets, a handheld device, an internet enabled calling device, an internet enabled calling software, a telephone, a mobile phone, a digital processing system, and so forth. The computing devices 102, 104 may include the processor 110 in communication with a memory 114. The processor 110 may be a central processing unit or a graphics processing unit. The memory 114 is a combination of flash memory and random-access memory.

The computing devices 102, 104 may communicatively connect with the server 108 over the network 106. The network 106 may include, but not limited to, an Internet of things (IoT network devices), an Ethernet, a wireless local area network (WLAN), or a wide area network (WAN), a Bluetooth low energy network, a ZigBee network, a WIFI communication network e.g., the wireless high speed internet, or a combination of networks, a cellular service such as a 4G (e.g., LTE, mobile WiMAX) or 5G cellular data service, a RFID module, a NFC module, wired cables, such as the world-wide-web based Internet, or other types of networks may include Transport Control Protocol/Internet Protocol (TCP/IP) or device addresses (e.g. network-based MAC addresses, or those provided in a proprietary networking protocol, such as Modbus TCP, or by using appropriate data feeds to obtain data from various web services, including retrieving XML data from an HTTP address, then traversing the XML for a particular node) and so forth without limiting the scope of the present disclosure. The network 106 may be configured to provide access to different types of users.

Although the first computing device 102 or second computing device 104 is shown in FIG. 1, an embodiment of the system 100 may support any number of computing devices. The first computing device 102 or second computing device 104 may be operated by the users. The users may include, but not limited to, an individual, a client, an operator, a content creator, and the like. The first computing device 102 or second computing device 104 supported by the system 100 is realized as a computer-implemented or computer-based device having the hardware or firmware, software, and/or processing logic needed to carry out the computer-implemented methodologies described in more detail herein.

In accordance with one or more exemplary embodiments of the present disclosure, the computing devices 102, 104 includes the camera 112 may be configured to enable the user to record the multimedia content using the processor 110. The computing devices 102, 104 may include the content creation and bounties generation module 116 in the memory 114. The content creation and bounties generation 116 may be configured to enable the user to access the bounty icon and allow the access the media tracks with bounties details. The content creation and bounties generation module 116 may also be configured to create content by using the media tracks. The multimedia content may include, but not limited to videos, short videos, looping videos, animated videos, and the like. The content creation and bounties generation module 116 may be any suitable applications downloaded from GOOGLE PLAY® (for Google Android devices), Apple Inc.'s APP STORE® (for Apple devices), or any other suitable database. The content creation and bounties generation module 116 may be desktop application which runs on Windows or Linux or any other operating system and may be downloaded from a webpage or a CD/USB stick etc. In some embodiments, the content creation and bounties generation module 116 may be software, firmware, or hardware that is integrated into the computing devices 102, 104. The computing devices 102, 104 may present a web page to the user by way of a browser, wherein the webpage comprises a hyper-link may direct the user to uniform resource locator (URL).

The server 108 may include the user activities monitoring module 118, the database server 120, the database 122. The user activities monitoring module 118 may be configured to analyze the user created content and provide milestones to the user. The user activities monitoring module 118 may also be configured to offer the bounties to the user based on the user posted content and the engagement of that posted content. The bounties may include but not limited to virtual awards, cash, cryptocurrency, status, coupons, or other rewards, and the like. The user activities monitoring module 118 may also be configured to provide server-side functionality via the network 106 to one or more users. The database server 120 may be configured to access the one or more databases. The database 122 may be configured to store the user created content and interactions between the modules of the content creation and bounties generation module 116 and the user activities monitoring module 118.

In accordance with one or more exemplary embodiments of the present disclosure, the content creation and bounties generation module 116 may be configured to enable the user to request media tracks on the computing devices 102 or 104. The content creation and bounties generation module 116 may be configured to allow the user to access the media tracks on the computing devices 102, 104. The content creation and bounties generation module 116 may be configured to allow the user to select and trim the media tracks. The content creation and bounties generation module 116 may be configured to allow the user to create the content using the trimmed media tracks. The content creation and bounties generation module 116 may be configured to allow the user to post the created content.

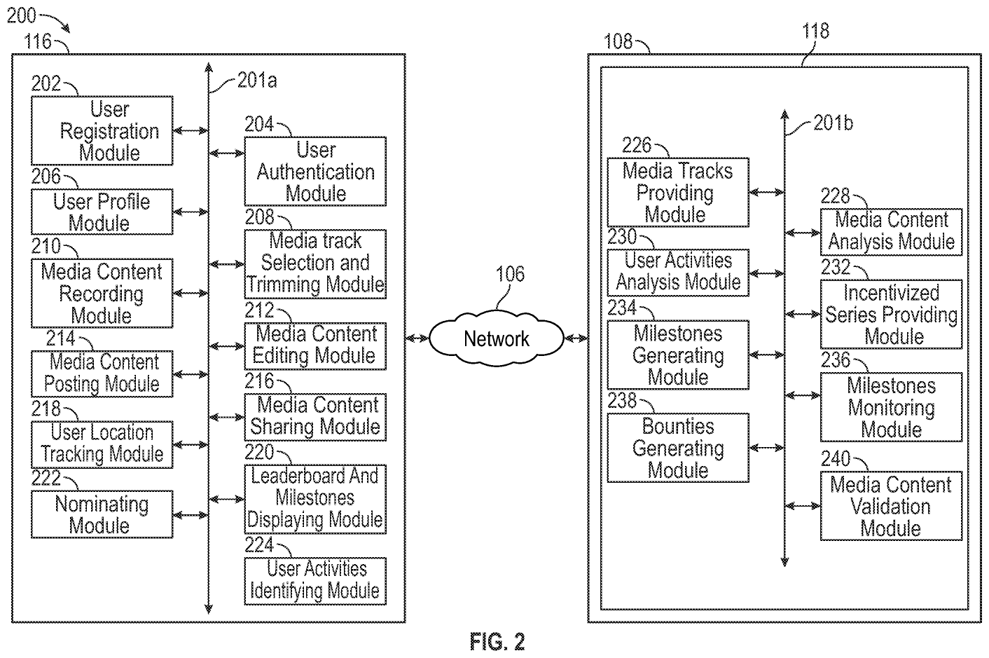

Referring to FIG. 2 is a block diagram 200 depicting an embodiment of the content creation and bounties generation module 116 on the computing devices and the user activities monitoring module 118 on the server as shown in FIG. 1, in accordance with one or more exemplary embodiments. The content creation and bounties generation module 116 includes a bus 201a, user registration module 202, a user authentication module 204, a user profile module 206, a media track selection and trimming module 208, a media content recording module 210, a media content editing module 212, a media content posting module 214, a media content sharing module 216, a user location tracking module 218, a leaderboard and milestones displaying module 220, a nominating module 222, and a user activities identifying module 224. The bus 201a may include a path that permits communication among the modules of the content creation and bounties generation module 116 installed on the computing devices 102, 104. The term “module” is used broadly herein and refers generally to a program resident in the memory 114 of the computing devices 102, 104.

The user registration module 202 may be configured to enable the user to register on the content creation and bounties generation module 116 installed on the computing devices 102, 104 by providing basic details of the user. The user authentication module 204 may be configured to enable the user to log in and access the content creation and bounties generation module 116 installed on the computing devices 102, 104 by using the user's user identity. The user profile module 206 may be configured to store the bounties of the user. The user profile module 206 may be configured to allow the user to access the bounties. The media track selection and trimming module 208 may be configured to allow the user to select and trim the media tracks. The media content recording module 210 may be configured to enable the user to create or record the content using the trimmed media tracks. The trimmed tracks may include one or more music clips. The media content editing module 212 may be configured to enable the user to edit the created content. The media content posting module 214 may be configured to allow the user to post the created content on the computing devices 102, 104. The media content sharing module 216 may be configured to enable the user to share the user created content with other end users. The user location tracking module 218 may be configured to track the location of the computing devices 102, 104. The leaderboard and milestones displaying module 220 may be configured to display the leaderboard to the user. The leaderboard may include the details of the milestones and the details associated with the bounties. The nominating module 222 may be configured to enable the user to nominate their favorite creators or other users for the awards or bounties. The user activities identifying module 224 may be configured to identify the user activities and sends to the server 108.

In accordance with one or more exemplary embodiments of the present disclosure, the user activities monitoring module 118 includes a bus 201b, a media tracks providing module 226, a media content analysis module 228, a user activities analysis module 230, an incentivized series providing module 232, a milestones generating module 234, a milestones monitoring module 236, a bounties generating module 238, and a media content validation module 240. The bus 201b may include a path that permits communication among the modules of the user activities monitoring module 118 installed on the sever 108.

In accordance with one or more exemplary embodiments of the present disclosure, the media tracks providing module 226 may be configured to retrieve media tracks with bounties details and delivers to the computing device. The media content analysis module 228 may be configured to analyze the user posted content on the computing device. The user activities analysis module 230 may be configured to analyze the user activities. The activities may include watching time of the incentivized videos. The incentivized series providing module 232 may be configured to provide incentivized video series with customized bounties to the computing device. The milestones generating module 234 may be configured to generate milestones to the user based on the user posted content. The milestones generating module 234 may be configured to generate milestones to the user based on the analyzed results of the media content analysis module 228. The milestones generating module 234 may be configured to generate milestones to the user based on the engagement of the user posted content. The milestones generating module 234 may be configured to add the user a first highest or a second highest milestone winner slots based on the user milestones. The milestones monitoring module 236 may be configured to monitor and calculate the milestone of the user. The milestones monitoring module 236 may be configured to detect the completion of the winner slots of the milestones. The bounties generating module 238 may be configured to offer the bounties to the user based on the milestones of the user. The bounties generating module 238 may be configured to freezing the milestones on the leaderboard. The bounties generating module 238 may be configured to offer the bounties to the user based on the user view time of the incentivized video series. The media content validation module 240 may be configured to validate the user created content.

In accordance with one or more exemplary embodiments of the present disclosure, offering the one or more bounties to the user based on the user activities. The user activities may include accessing the icons, trimming the media track, and the like.

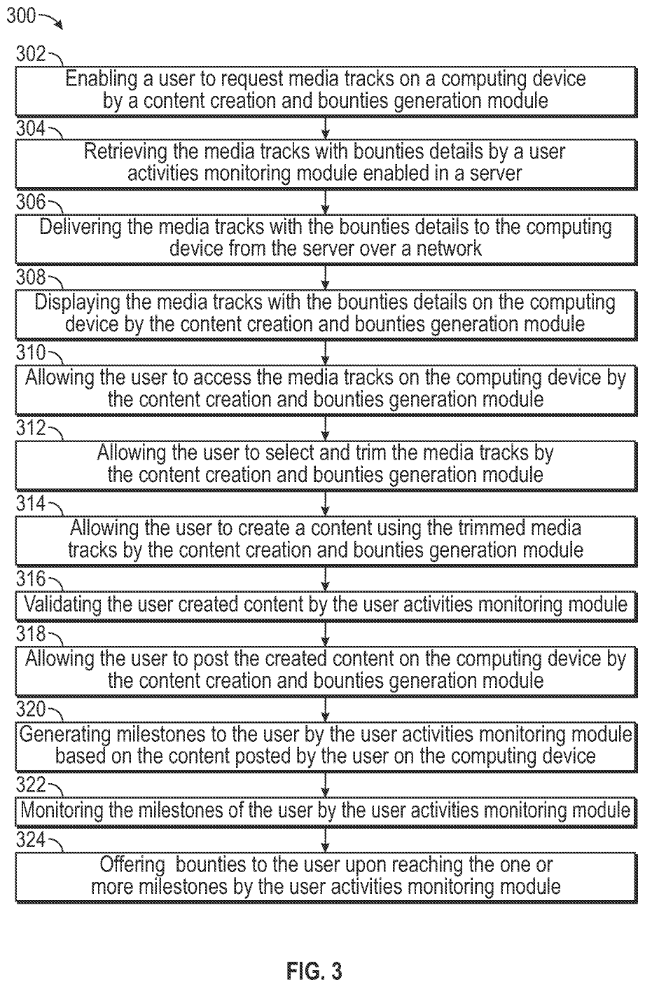

Referring to FIG. 3 is a flow diagram 300 depicting a method for offering bounties to a user in real-time, in accordance with one or more exemplary embodiments. The method 300 may be carried out in the context of the details of FIG. 1, and FIG. 2. However, the method 300 may also be carried out in any desired environment. Further, the aforementioned definitions may equally apply to the description below.

The method commences at step 302, enabling the user to request media tracks on the computing device by the content creation and bounties generation module. Thereafter at step 304, retrieving the media tracks with bounties details by the user activities monitoring module enabled in the server. Thereafter at step 306, delivering the media tracks with the bounties details to the computing device from the server over the network. Thereafter at step 308, displaying the media tracks with the bounties details on the computing device by the content creation and bounties generation module. Thereafter at step 310, allowing the user to access the media tracks on the computing device by the content creation and bounties generation module. Thereafter at step 312, allowing the user to select and trim the media tracks by the content creation and bounties generation module. Thereafter at step 314, allowing the user to create the content using the trimmed media tracks by the content creation and bounties generation module. Thereafter at step 316, validating the user created content by the user activities monitoring module. Thereafter at step 318, allowing the user to post the created content on the computing device by the content creation and bounties generation module. Thereafter at step 320, generating milestones to the user by the user activities monitoring module based on the content posted by the user on the computing device. Thereafter at step 322, monitoring the milestones of the user by the user activities monitoring module. Thereafter at step 324, offering the bounties to the user upon reaching the one or more milestones by the user activities monitoring module.

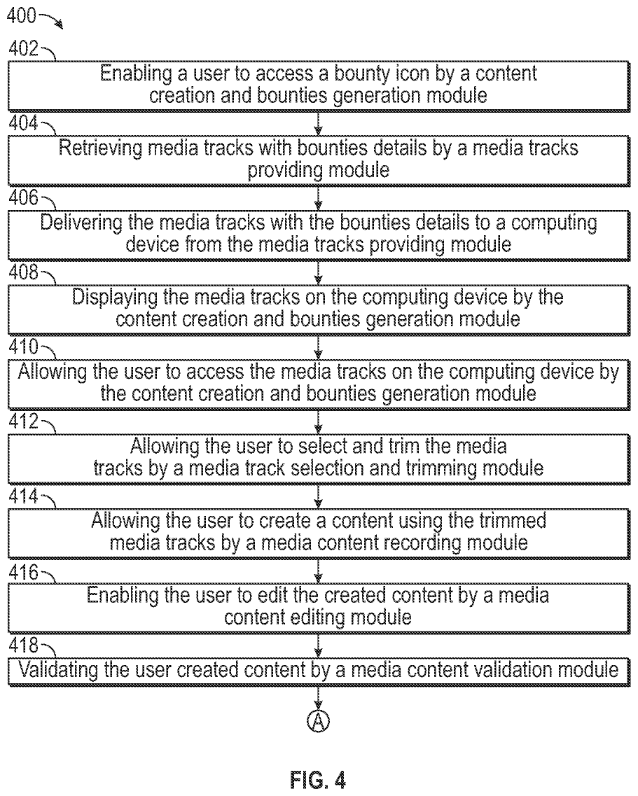

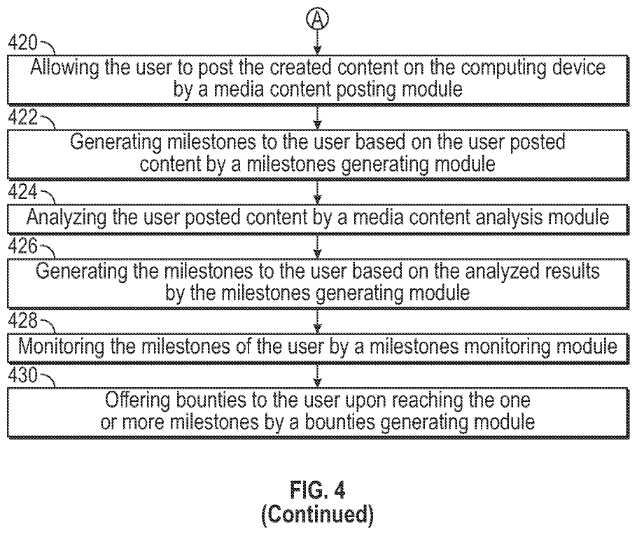

Referring to FIG. 4 is a flow diagram 400 depicting a method for accessing media tracks and posting the content, in accordance with one or more exemplary embodiments. The method 400 may be carried out in the context of the details of FIG. 1, FIG. 2, and FIG. 3. However, the method 400 may also be carried out in any desired environment. Further, the aforementioned definitions may equally apply to the description below.

The method commences at step 402, enabling the user to access the bounty icon by the content creation and bounties generation module. Thereafter at step 404, retrieving the media tracks with bounties details by the media tracks providing module. Thereafter at step 406, delivering the media tracks with the bounties details to the computing device from the media tracks providing module. Thereafter at step 408, displaying the media tracks on the computing device by the content creation and bounties generation module. Thereafter at step 410, allowing the user to access the media tracks on the computing device by the content creation and bounties generation module. Thereafter at step 412, allowing the user to select and trim the media tracks by the media track selection and trimming module. Thereafter at step 414, allowing the user to create the content using the trimmed media tracks by the media content recording module. Thereafter at step 416, enabling the user to edit the created content by the media content editing module. Thereafter at step 418, validating the user created content by the media content validation module. Thereafter at step 420, allowing the user to post the created content on the computing device by the media content posting module. Thereafter at step 422, generating the milestones to the user based on the user posted content by the milestones generating module. Thereafter at step 424, analyzing the user posted content by the media content analysis module. Thereafter at step 426, generating the milestones to the user based on the analyzed results by the milestones generating module. Thereafter at step 428, monitoring the milestones of the user by the milestones monitoring module. Thereafter at step 430, offering bounties to the user upon reaching the one or more milestones by the bounties generating module.

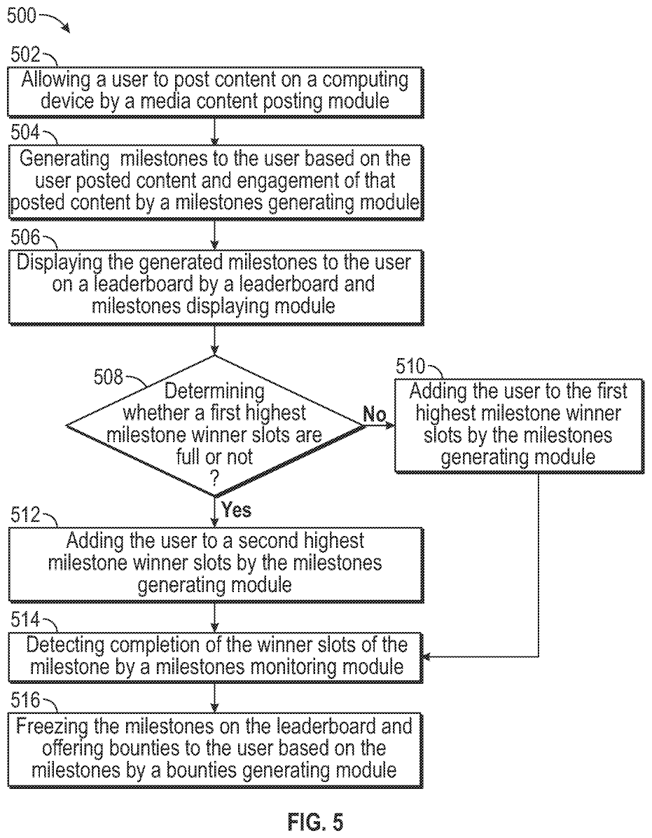

Referring to FIG. 5 is a flow diagram depicting a method for generating milestones and adding the user to winner slots of milestones, in accordance with one or more exemplary embodiments. The method 500 may be carried out in the context of the details of FIG. 1, FIG. 2, FIG. 3, and FIG. 4. However, the method 500 may also be carried out in any desired environment. Further, the aforementioned definitions may equally apply to the description below.

The method commences at step 502, allowing the user to post the content on the computing device by the media content posting module. Thereafter at step 504, generating the milestones to the user based on the user posted content and engagement of that posted content by the milestones generating module. Thereafter at step 506, displaying the generated milestones to the user on the leaderboard by the leaderboard and milestones displaying module. Determining whether a first highest milestone winner slots are full or not, at step 508. If answer at step 508 is Yes, the method continues at step 512, adding the user to the second highest milestone winner slots by the milestones generating module. If answer at step 508 is No, the method continues at step 510, adding the user to the first highest milestone winner slots by the milestones generating module. Thereafter at step 514, detecting completion of the winner slots of the milestone by the milestones monitoring module. Thereafter at step 516 freezing the milestones on the leaderboard and offering bounties to the user based on the milestones by the bounties generating module.

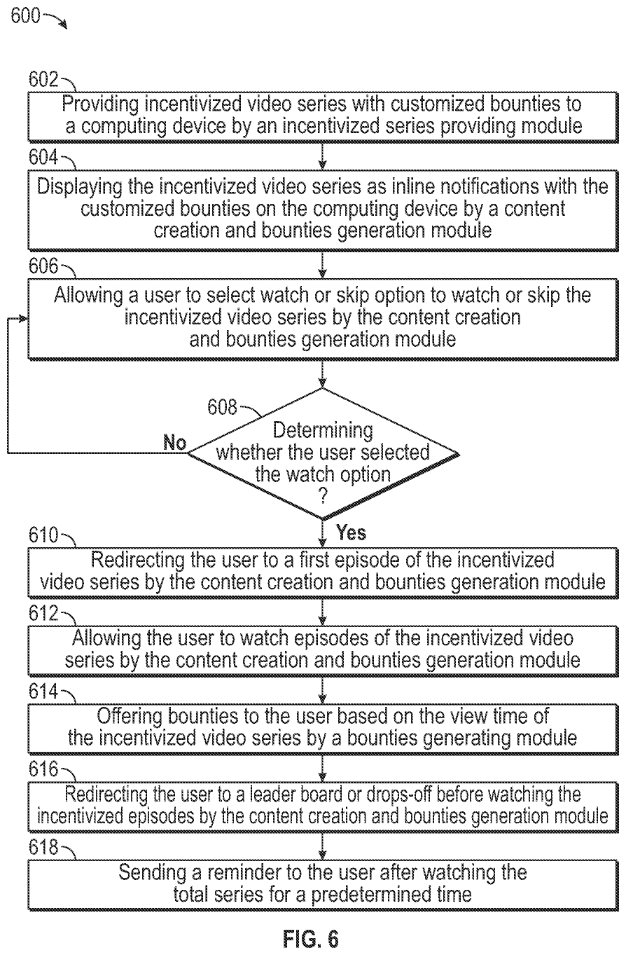

Referring to FIG. 6 is a flow diagram depicting a method for providing incentivized series to the user by an incentivized series providing module, in accordance with one or more exemplary embodiments. The method 600 may be carried out in the context of the details of FIG. 1, FIG. 2, FIG. 3, FIG. 4, and FIG. 5. However, the method 600 may also be carried out in any desired environment. Further, the aforementioned definitions may equally apply to the description below.

The method commences at step 602, providing incentivized video series with customized bounties to the computing device by the incentivized series providing module. Thereafter at step 604, displaying the incentivized video series as inline notifications with the customized bounties on the computing device by the content creation and bounties generation module. Thereafter at step 606, allowing the user to select watch or skip option to watch or skip the incentivized video series by the content creation and bounties generation module. Determining whether the user selected the watch option, at step 608. If answer at step 608 is Yes, the method continues at step 610, redirecting the user to the first episode of the incentivized video series by the content creation and bounties generation module. Thereafter at step 612, allowing the user to watch episodes of the incentivized video series by the content creation and bounties generation module. Thereafter at step 614, offering bounties to the user based on the view time of the incentivized video series by the bounties generating module. Thereafter at step 616, redirecting the user to the leader board or drops-off before watching the incentivized episodes by the content creation and bounties generation module. Thereafter at step 618, sending the reminder to the user after watching the total series for a predetermined time. If answer at step 608 is No, the method reverts at step 606.

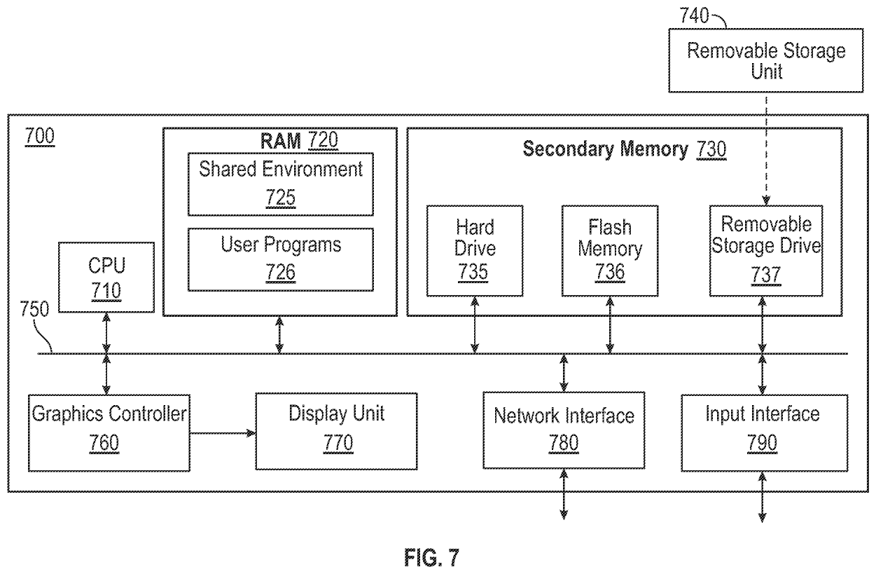

Referring to FIG. 7 is a block diagram 700 illustrating the details of a digital processing system 700 in which various aspects of the present disclosure are operative by execution of appropriate software instructions. The Digital processing system 700 may correspond to the first computing devices 102, 104 (or any other system in which the various features disclosed above can be implemented).

Digital processing system 700 may contain one or more processors such as a central processing unit (CPU) 710, random access memory (RAM) 720, secondary memory 730, graphics controller 760, display unit 770, network interface 780, and input interface 790. All the components except display unit 770 may communicate with each other over communication path 750, which may contain several buses as is well known in the relevant arts. The components of FIG. 7 are described below in further detail.

CPU 710 may execute instructions stored in RAM 720 to provide several features of the present disclosure. CPU 710 may contain multiple processing units, with each processing unit potentially being designed for a specific task. Alternatively, CPU 710 may contain only a single general-purpose processing unit.

RAM 720 may receive instructions from secondary memory 730 using communication path 750. RAM 720 is shown currently containing software instructions, such as those used in threads and stacks, constituting shared environment 725 and/or user programs 726. Shared environment 725 includes operating systems, device drivers, virtual machines, etc., which provide a (common) run time environment for execution of user programs 726.

Graphics controller 760 generates display signals (e.g., in RGB format) to display unit 770 based on data/instructions received from CPU 710. Display unit 770 contains a display screen to display the images defined by the display signals. Input interface 790 may correspond to a keyboard and a pointing device (e.g., touch-pad, mouse) and may be used to provide inputs. Network interface 780 provides connectivity to a network (e.g., using Internet Protocol), and may be used to communicate with other systems (such as those shown in FIG. 1) connected to the network 106.

Secondary memory 730 may contain hard drive 735, flash memory 736, and removable storage drive 737. Secondary memory 730 may store the data software instructions (e.g., for performing the actions noted above with respect to the Figures), which enable digital processing system 700 to provide several features in accordance with the present disclosure.

Some or all of the data and instructions may be provided on removable storage unit 740, and the data and instructions may be read and provided by removable storage drive 737 to CPU 710. Floppy drive, magnetic tape drive, CD-ROM drive, DVD Drive, Flash memory, removable memory chip (PCMCIA Card, EEPROM) are examples of such removable storage drive 737.

Removable storage unit 740 may be implemented using medium and storage format compatible with removable storage drive 737 such that removable storage drive 737 can read the data and instructions. Thus, removable storage unit 740 includes a computer readable (storage) medium having stored therein computer software and/or data. However, the computer (or machine, in general) readable medium can be in other forms (e.g., non-removable, random access, etc.).

In this document, the term “computer program product” is used to generally refer to removable storage unit 740 or hard disk installed in hard drive 735. These computer program products are means for providing software to digital processing system 700. CPU 710 may retrieve the software instructions, and execute the instructions to provide various features of the present disclosure described above.

The term “storage media/medium” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage memory 730. Volatile media includes dynamic memory, such as RAM 720. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus (communication path) 750. Transmission media can also take the form of acoustic or light waves, such as those generated during radio-wave and infra-red data communications.

According to an exemplary aspect of the present disclosure, enabling the user to request one or more media tracks on a computing device by a content creation and bounties generation module 116.

According to another exemplary aspect of the present disclosure, retrieving the one or more media tracks with bounties details by a user activities monitoring module 118 enabled in a server 108.

According to another exemplary aspect of the present disclosure, delivering the one or more media tracks with the bounties details to the computing device from the server 108 over a network 106, thereby displaying the one or more media tracks with the bounties details on the computing device by the content creation and bounties generation module 116.

According to another exemplary aspect of the present disclosure, allowing the user to access the one or more media tracks on the computing device by the content creation and bounties generation module 116.

According to another exemplary aspect of the present disclosure, allowing the user to select and trim the one or more media tracks by the content creation and bounties generation module 116.

According to another exemplary aspect of the present disclosure, allowing the user to create a content using the one or more trimmed media tracks by the content creation and bounties generation module 116.

According to another exemplary aspect of the present disclosure, validating the user created content by the user activities monitoring module 118 enabled in the server 108.

According to another exemplary aspect of the present disclosure, allowing the user to post the created content on the computing device by the content creation and bounties generation module 116.

According to another exemplary aspect of the present disclosure, generating one or more milestones to the user by the user activities monitoring module 118 based on the content posted by the user on the computing device.

According to another exemplary aspect of the present disclosure, monitoring the one or more milestones of the user by the user activities monitoring module 118.

According to another exemplary aspect of the present disclosure, offering one or more bounties to the user upon reaching the one or more milestones by the user activities monitoring module 118.

According to another exemplary aspect of the present disclosure, a computing device configured to establish communication with a server 108 over a network 106, whereby the computing device comprises a memory 114 configured to store multimedia content captured using a camera 112.

According to another exemplary aspect of the present disclosure, the computing device comprises a content creation and bounties generation module configured to enable a user to access a bounty icon, whereby the content creation and bounties generation module 116 configured to receive one or more media tracks with bounties details from the server 108, the content creation and bounties generation module 116 configured to allow the user to access, select and trim the one or more media tracks on the computing device, the content creation and bounties generation module configured 116 to enable the user to create a content by using the one or more trimmed media tracks and to post the created content on the computing device.

According to another exemplary aspect of the present disclosure, the server 108 comprises a user activities monitoring module 118 configured to validate the user posted content and generates one or more milestones to the user based on the user posted content, the user activities monitoring module 118 configured to analyze the user content posted on the computing device and generates the one or more milestones to the user based on the one or more user activities, the user activities monitoring module 118 also configured to generate one or more bounties to the user upon reaching one or more milestones.

Reference throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

Furthermore, the described features, structures, or characteristics of the disclosure may be combined in any suitable manner in one or more embodiments. In the above description, numerous specific details are provided such as examples of programming, software modules, user selections, network transactions, database queries, database structures, hardware modules, hardware circuits, hardware chips, etc., to provide a thorough understanding of embodiments of the disclosure.

Although the present disclosure has been described in terms of certain preferred embodiments and illustrations thereof, other embodiments and modifications to preferred embodiments may be possible that are within the principles and spirit of the invention. The above descriptions and figures are therefore to be regarded as illustrative and not restrictive.

Thus the scope of the present disclosure is defined by the appended claims and includes both combinations and sub-combinations of the various features described hereinabove as well as variations and modifications thereof, which would occur to persons skilled in the art upon reading the foregoing description.

What is claimed is:

1. A method for offering bounties to a user in real-time, comprising:
enabling the user to request one or more media tracks on a computing device by a content creation and bounties generation module;
retrieving the one or more media tracks with bounties details by a user activities monitoring module enabled in a server;
delivering the one or more media tracks with the bounties details to the computing device from the server over a network, thereby displaying the one or more media tracks with the bounties details on the computing device by the content creation and bounties generation module;
allowing the user to access the one or more media tracks on the computing device by the content creation and bounties generation module;
allowing the user to select and trim the one or more media tracks by the content creation and bounties generation module;
allowing the user to create a content using the one or more trimmed media tracks by the content creation and bounties generation module;
validating the user created content by the user activities monitoring module enabled in the server;
allowing the user to post the created content on the computing device by the content creation and bounties generation module;
generating one or more milestones to the user by the user activities monitoring module based on the content posted by the user on the computing device;
monitoring the one or more milestones of the user by the user activities monitoring module; and
offering one or more bounties to the user upon reaching the one or more milestones by the user activities monitoring module.

2. The method of claim 1, comprising a step of enabling the user to access a bounty icon by the content creation and bounties generation module.

3. The method of claim 1, comprising a step of delivering the one or more media tracks, hashtags, prompts, templates, and films with the bounties details to the computing device by a media tracks providing module enabled in the server over the network.

4. The method of claim 1, comprising a step of allowing the user to select and trim the one or more media tracks by a media track selection and trimming module.

5. The method of claim 1, comprising a step of allowing the user to create the content using the one or more trimmed media tracks by a media content recording module.

6. The method of claim 1, comprising a step of validating the user created content by a media content validation module.

7. The method of claim 1, comprising a step of allowing the user to post the created content on the computing device by a media content posting module.

8. The method of claim 1, comprising a step of analyzing the user posted content by a media content analysis module.

9. The method of claim 1, comprising a step of generating the one or more milestones to the user by a milestones generating module based on the user posted content and the analyzed results.

10. The method of claim 9, comprising a step of displaying the one or more generated milestones to the user on a leaderboard by a leaderboard and milestones displaying module.

11. The method of claim 10, comprising a step of adding the user as at least one of: a first highest milestone winner slots; and a second highest milestone winner slots by the milestones generating module.

12. The method of claim 1, comprising a step of monitoring the one or more milestones of the user by a milestones monitoring module.

13. The method of claim 12, comprising a step of freezing the one or more milestones on the leaderboard and offering one or more bounties to the user by a bounties generating module.

14. The method of claim 1, comprising a step of offering the one or more bounties to the user based on the user activities by the bounties generating module.

15. The method of claim 1, comprising a step of providing incentivized video series with customized bounties to the computing device by an incentivized series providing module enabled in the server.

16. The method of claim 15, comprising a step of displaying the incentivized video series as inline notifications with the customized bounties on the computing device by the content creation and bounties generation module.

17. The method of claim 16, comprising a step of allowing the user to watch one or more episodes of the incentivized video series on the computing device by the content creation and bounties generation module.

18. The method of claim 17, comprising a step of offering the one or more bounties to the user based on the view time of the incentivized video series by the bounties generating module.

19. A system for offering bounties to a user in real-time, comprising:
a computing device configured to establish communication with a server over a network, whereby the computing device comprises a memory configured to store multimedia content captured using a camera;
the computing device comprises a content creation and bounties generation module configured to enable a user to access a bounty icon, whereby the content creation and bounties generation module configured to receive one or more media tracks with bounties details from the server, the content creation and bounties generation module configured to allow the user to access, select and trim the one or more media tracks on the computing device, the content creation and bounties generation module configured to enable the user to create a content by using the one or more trimmed media tracks and to post the created content on the computing device; and
the server comprises a user activities monitoring module configured to validate the user posted content and generates one or more milestones to the user based on the user posted content, whereby the user activities monitoring module configured to analyze the user content posted on the computing device and generates the one or more milestones to the user based on the one or more user activities, the user activities monitoring module also configured to generate one or more bounties to the user upon reaching one or more milestones.

20. A computer program product comprising a non-transitory computer-readable medium having a computer-readable program code embodied therein to be executed by one or more processors, said program code including instructions to:
enable a user to request one or more media tracks on a computing device by a content creation and bounties generation module;
retrieve one or more media tracks with bounties details by a user activities monitoring module enabled in a server;
deliver the one or more media tracks with bounties details to the computing device from the server over a network, thereby display the one or more media tracks with the bounties details on the computing device by the content creation and bounties generation module;
allow the user to access the one or more media tracks on the computing device by the content creation and bounties generation module;
allow the user to select and trim the one or more media tracks by the content creation and bounties generation module;
enable the user to create a content using the one or more trimmed media tracks by the content creation and bounties generation module;
validate the user created content by the user activities monitoring module enabled in the server;
allow the user to post the created content on the computing device by the content creation and bounties generation module;
generate one or more milestones to the user by the user activities monitoring module based on the content posted by the user on the computing device;
monitor the one or more milestones of the user by the user activities monitoring module; and
offer one or more bounties to the user upon reaching the one or more milestones by the user activities monitoring module.
